(19) United States
(12) Patent Application Publication
(10) Pub. No.: US 2018/0175506 A1
(43) Pub. Date: Jun. 21, 2018

(54) Antenna Device

(71) Applicant: Korea Advanced Institute of Science and Technology, Daejeon (KR)

(72) Inventors: Chul-Soon PARK, Daejeon (KR); Tae-Hwan JANG, Daejeon (KR); Hong-Yi KIM, Daejeon (KR)

(73) Assignee: Korea Advanced Institute of Science and Technology, Daejeon (KR)

(21) Appl. No.: 15/841,687

(22) Filed: Dec. 14, 2017

(30) Foreign Application Priority Data
Dec. 19, 2016 (KR) 10-2016-0173669

(51) Int. Cl. H01Q 13/02; H04B 7/08

(52) U.S. Cl. CPC H01Q 13/0233; H04B 7/086

(57) ABSTRACT

An antenna device includes a horn antenna including a waveguide and a horn connected to the waveguide, the horn having a shape widening toward an opening direction, a beamforming network including a plurality of input ports and a plurality of output ports and changing a phase of output port signals output from the output ports based on input port signals applied to the input ports, and an antenna array disposed in the horn antenna and connected to the output ports of the beamforming network.

### CROSS REFERENCE TO RELATED APPLICATION

This application claims priority under 35 U.S.C. § 119 to Korean Patent Application No. 10-2016-0173669 filed on Dec. 19, 2016, the disclosure of which is hereby incorporated by reference herein in its entirety.

### BACKGROUND

### 1. Technical Field

Example embodiments of the inventive concept relate to a wireless communication system. More particularly, example embodiments of the inventive concept relate to a horn antenna device capable of beam switching.

### 2. Description of the Related Art

Recently, various antenna systems for high-speed and large-capacity data communication with millimeter-wave band and for wireless communication interfacing between chips have been developed. Since a large energy loss occurs for wireless transmissions, a wireless communication system with a large antenna gain is required to reduce power consumption of the wireless communication system.

Generally, a horn antenna device includes a feed part generating a signal, a waveguide having an inner space of which one end is opened, and a horn having a shape widening toward an opening direction. Generally, the horn antenna device has advantages of a self-shielding effect, a wide bandwidth, and a relatively large antenna gain. However, the horn antenna device has a disadvantage in that it is impossible to perform beam switching.

### SUMMARY

Example embodiments provide a horn antenna device capable of performing beam switching.

According to some example embodiments, an antenna device may include a horn antenna including a waveguide and a horn connected to the waveguide, the horn having a shape widening toward an opening direction, a beamforming network including a plurality of input ports and a plurality of output ports and configured to change a phase of output port signals output from the output ports based on input port signals applied to the input ports, and an antenna array disposed in the horn antenna and connected to the output ports of the beamforming network.

In example embodiments, the beamforming network may include a butler matrix.

In example embodiments, the butler matrix may include a first stage, a second stage, and a third stage. Each of the first stage and the third stage includes a 3 dB coupler. The second stage between the first stage and the third stage includes a 0 dB coupler and a delay line.

In example embodiments, the antenna array may include a Yagi-Uda antenna.

In example embodiments, the antenna array may extend from the output ports of the beamforming network in the opening direction at a center line of a cross-section of the horn antenna and may be located in the horn.

In example embodiments, the antenna device may further include a beam switch configured to provide an input signal to one of the input ports of the beamforming network.

According to some example embodiments, an antenna device may include a horn antenna having a shape widening toward an opening direction, and a beam switching antenna extending in the opening direction at a center line of a cross-section of the horn antenna and configured to perform a beam switching operation, the beam switching operation changing a phase of output port signals output from output ports based on input port signals applied to input ports.

Therefore, the antenna device according to example embodiments may include the horn antenna structure in which a beam switching antenna array (e.g., Yagi-Uda antenna array) capable of performing beam switching is embedded. Accordingly, the antenna device can have advantages of beam-switching as well as advantages of the horn antenna such as a large antenna gain, a self-shielding effect, etc. In addition, because the antenna device has large gain and wide bandwidth characteristics of the horn antenna, the antenna device can be applied to a low power broadband communication system.

### BRIEF DESCRIPTION OF THE DRAWINGS

Exemplary embodiments will be described more fully hereinafter with reference to the accompanying drawings, in which various embodiments are shown.

FIG. 1 is a diagram illustrating an antenna device according to example embodiments.

FIG. 2 is a diagram illustrating an example of a beam-switching antenna structure included in the antenna device of FIG. 1.

FIG. 3 is a diagram illustrating an example of a beamforming network and an antenna array included in the beam-switching antenna structure of FIG. 2.

FIG. 4 is a diagram illustrating an example of an E-Plane radiation pattern of the antenna device of FIG. 1 according to input port signals.

FIGS. 5 and 6 are diagrams for describing an input reflection coefficient of the antenna device of FIG. 1 according to input port signals.

FIGS. 7 and 8 are diagrams for describing an antenna gain of the antenna device of FIG. 1 according to input port signals.

### DESCRIPTION OF EMBODIMENTS

Various example embodiments will be described more fully hereinafter with reference to the accompanying drawings, in which some example embodiments are shown. The present inventive concept may, however, be embodied in many different forms and should not be construed as limited to the example embodiments set forth herein. Rather, these example embodiments are provided so that this disclosure will be thorough and complete, and will fully convey the scope of the present inventive concept to those skilled in the art. In the drawings, the sizes and relative sizes of layers and regions may be exaggerated for clarity. Like numerals refer to like elements throughout.

It will be understood that, although the terms first, second, third etc, may be used herein to describe various elements, these elements should not be limited by these terms. These terms are used to distinguish one element from another. Thus, a first element discussed below could be termed a second element without departing from the teachings of the present inventive concept. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular example embodiments only and is not intended to be limiting of the present inventive concept. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

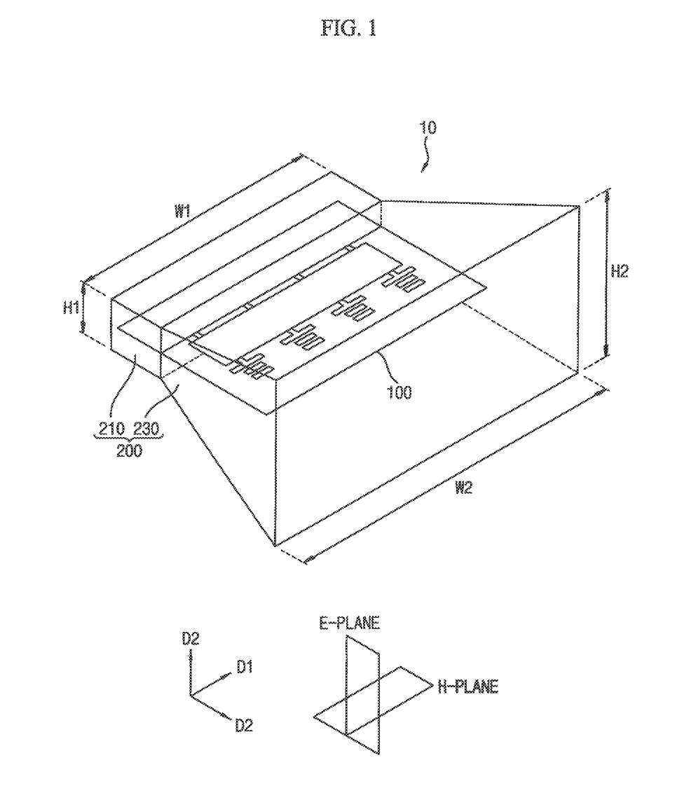

FIG. 1 is a diagram illustrating an antenna device according to example embodiments.

Referring to FIG. 1, the antenna device 10 may include a beam switching antenna 100 and a horn antenna 200. In the antenna device 10, the beam switching antenna 100 capable of beam switching operation may be embedded in the horn antenna 200 to implement the horn antenna capable of beam-switching.

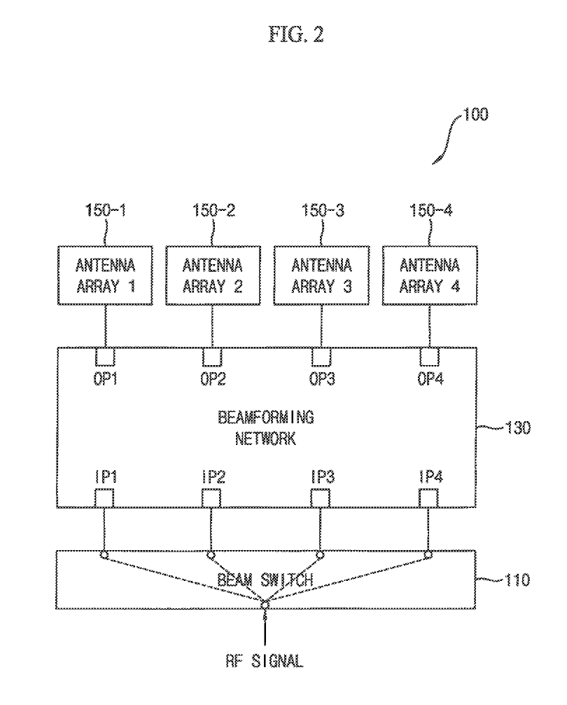

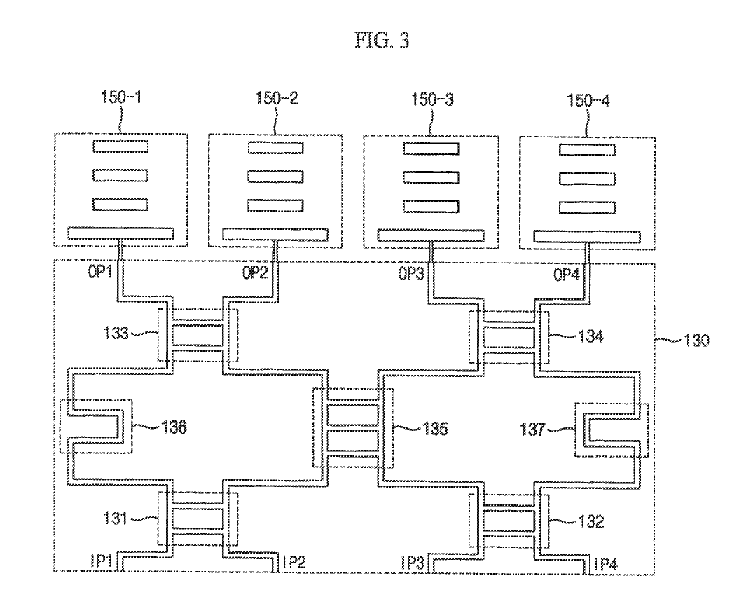

The beam switching antenna 100 may be disposed inside of the horn antenna 200 and may perform the beam switching operation. The beam switching antenna 100 may change a phase of output port signals output from output ports based on input port signals applied to input ports. Accordingly, the beam switching antenna 100 may perform the beam switching operation in which E-Plane radiation pattern is changed according to the input port signal. In one example embodiment, the beam switching antenna 100 may include a beamforming network changing the phase of the output port signals output from the output ports based on the input port signals applied to the input ports and an antenna array disposed in the horn antenna 200 and connected to the output ports of the beamforming network. Hereinafter, a structure of the beam switching antenna 100 will be described in more detail with reference to the FIGS. 2 and 3.

The horn antenna 200 may have a shape widening toward an opening direction to increase directivity and gain of the antenna. Accordingly, the horn antenna 200 may have high electromagnetic wave transmitting/receiving capability in a specific direction (i.e., the opening direction) as compared with other directions. In one example embodiment, the horn antenna 200 may have a waveguide 210 and a horn 230.

The waveguide 210 may have an inner space of which one end has an opening. In one example embodiment, the waveguide 210 may have a rectangular parallelepiped shape. For example, a cross-section of the waveguide 210 may have a rectangular shape having a first width W1 extending in a first direction D1 and a first height H1 extending in a second direction D2.

The horn 230 may be connected to the waveguide 210 and may have a shape widening toward the opening direction. In one example embodiment, a cross-section of the horn 230 may have an increased width and height as compared to the cross-section of the waveguide 210. For example, an opening surface of the horn 230 have a rectangular shape having a second width W2 extending in a first direction D1 and a second height H2 extending in a second direction D2, where the second width W2 is greater than the first width W1 and the second height H2 is greater than the first height H1.

The beam switching antenna 100 may extend to the opening direction at a center line of a cross-section of the horn antenna 200 such that the beam switching antenna 100 overlaps with the horn 230. For example, when the cross-section of the waveguide 210 with respect to E-plane has the first height H1, the beam switching antenna 100 may extend in the opening direction (i.e., a third direction D3) at the middle of the first height H1 of the waveguide 210 and may be located inside of the horn 230.

Therefore, the antenna device 10 may include the horn antenna 200 in which the beam switching antenna 100 capable of beam switching operation is embedded. Accordingly, the antenna device 10 can be capable of beam-switching with the advantages of the horn antenna such as large antenna gain, self-shielding effect, etc.

Although the example embodiments of FIG. 1 describe that the waveguide 210 has the rectangular shape in the cross-section view, the shape of the waveguide is not limited thereto. For example, the waveguide may have various shapes such as a circle, an ellipse, a trapezoid, etc in cross-section view.

Although the example embodiments of FIG. 1 describe that the opening surface of the horn 230 has the increased width and increased height as compared to the cross-section of the waveguide 210, the shape of the horn is not limited thereto. For example, the opening surface of the horn 230 may have the increased width and the same height or may have the same width and the increased height as compared to the cross-section of the waveguide 210. In addition, the opening surface of the horn 230 may have various shapes such as a circle, an ellipse, a trapezoid, etc.

FIG. 2 is a diagram illustrating an example of a beam-switching antenna structure included in the antenna device of FIG. 1.

Referring to FIG. 2, the beam switching antenna 100 may be disposed inside of the horn antenna and may perform the beam switching operation. The beam switching antenna 100 may include a beam switch 110, a beamforming network 130, and an antenna array 150-1 through 150-4.

The beam switch 110 may receive an input signal and may provide the input signal to at least one of input ports of the beamforming network 130. For example, the beam switch 110 may receive a radio frequency (RF) signal as the input signal and may provide the input signal to one of the first through fourth input ports IP1 through IP4.

The beamforming network 130 may include a plurality of input ports and a plurality of output ports and may change a phase of output port signals output from the output ports based on input port signals applied to the input ports. For example, the beamforming network 130 may include a 4*4 butler matrix including the first through fourth input ports IP1 through IP4 and the first through fourth output ports OP1 through OP4.

The antenna array 150-1 through 150-4 may be connected to the output ports of the beamforming network 130 to steer the beam. In one example embodiment, the antenna array 150-1 through 150-4 may include Yagi-Uda antenna. For example, the first through fourth output ports OP1 through OP4 of the beamforming network 130 may be connected to the first through fourth Yagi-Uda antennas 150-1 through 150-4, respectively.

In addition, the beam switching antenna 100 may further include an attenuator for changing the amplitude of output signal.

Although the example embodiments of FIG. 2 describe that the beamforming network 130 includes four input ports and four output ports, the number of input ports and the number of output ports included in the beamforming network are not limited thereto. For example, the beamforming network includes eight input ports and eight output ports

Although the example embodiments of FIG. 2 describe that the number of input ports equals to the number of output ports in the beamforming network, the number of input ports and the number of output ports can be different.

FIG. 3 is a diagram illustrating an example of a beamforming network and an antenna array included in the beam-switching antenna structure of FIG. 2.

Referring to FIG. 3, the beamforming network 130 may include a 4*4 butler matrix including the first through fourth input ports IP1 through IP4 and the first through fourth output ports OP1 through OP4. The butler matrix may be formed of an upper metal and a lower metal and may consist of a plurality of stages. The butler matrix may include a 3 dB coupler, a 0 dB coupler, and a delay line. Accordingly, an output port signal having a phase difference may be output to the first through fourth output ports OP1 to OP4 of the beamforming network 130, and the phase may be changed according to the input port signal.

In one example embodiment, the beamforming network 130 may consist of the first through third stages. For example, the first stage may include a first 3 dB coupler 131 connected to a first input port IP1 and a second input port IP2, and a second 3 dB coupler 132 connected to a third input port IP3 and a fourth input port IP4. The second stage may include a first delay line 136 connected to the first 3 dB coupler 131, an 0 db coupler 135 connected to the first 3 dB coupler 131 and the second 3 dB coupler 132, and a second delay line 137 connected to the second 3 dB coupler 132. The third stage may include a third 3 dB coupler 133 connected to the first delay line 136 and the 0 db coupler 135, and a fourth 3 dB coupler 134 connected to the second delay line 137 and the 0 db coupler 135.

The first through fourth output ports (OP1 through OP4) of the beam forming network 130 may be connected to the first through fourth Yagi-Uda antennas 150-1 through 150-4, respectively. For example, each of the first through fourth Yagi-Uda antennas 150-1 through 150-4 may include a driven element transmitting radio waves as a half-wave dipole, a reflector including a conductor longer than ½ of the wavelength to reflect the radio wave emitted from the driven element, and a plurality of directors each including a conductor shorter than ½ the wavelength to enhance the radio waves emitted from the driven element. The radio wave emitted from the first through fourth Yagi-Uda antennas 150-1 through 150-4 may be changed according to a phase of current applied to the antennas.

Therefore, the switchable beamforming antenna capable of performing the beam-switching operation can be implemented with a relatively small size by using the Yagi-Uda antenna as the antenna array.

Although the example embodiments of FIGS. 2 and 3 describe that the beamforming network 130 is the butler matrix, the beamforming network may be one of various phase shifters as well as the butler matrix.

Although the example embodiments of FIG. 3 describe that the butler matrix consists of the first through third stages and includes the first through fourth 3 dB couplers, the first and second delay lines, and the 0 dB coupler, the butler matrix may have various structures for shifting the phase of the output port signal based on the input port signal.

Although the example embodiments of FIG. 3 describe that the antenna array includes Yagi-Uda antennas, the antenna array includes various types of antennas capable of performing beam-switching operations.

Although the example embodiments of FIGS. 2 and 3 describe that the beamforming network 130 includes one butler matrix, the beamforming network may includes a plurality of butler matrices. In addition, each of the plurality of butler matrices may include different types of antennas as the antenna array.

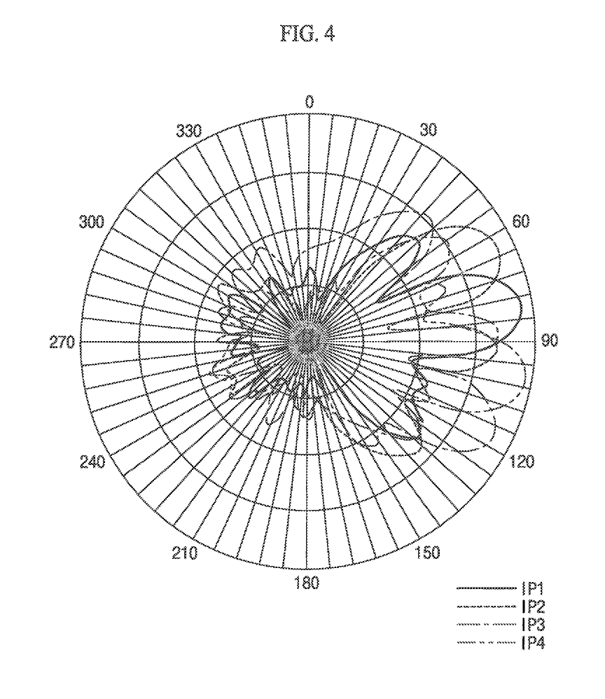

FIG. 4 is a diagram illustrating an example of an E-Plane radiation pattern of the antenna device of FIG. 1 according to input port signals.

Referring to FIG. 4, the antenna device includes the horn antenna in which the beam switching antenna capable of beam switching operation is embedded. The beam switching antenna includes the butler matrix described in FIG. 3 as a beamforming network and the first through fourth Yagi-Uda antennas connected to the first through fourth output ports of the beamforming network, respectively. Here, the butler matrix consists of the first through third stages and includes the first through fourth 3 dB couplers, the first and second delay lines, and the 0 dB coupler.

In this case, as shown in FIG. 4, it could be confirmed that different E-Plane radiation patterns are formed by selectively applying signals to the first through fourth input ports IP1 through IP4 of the beamforming network using the beam switch. In addition, the antenna device had the advantages of the horn antenna device such as high directivity and large gain of the antenna, and then the antenna device performed the beam switching operation correctly.

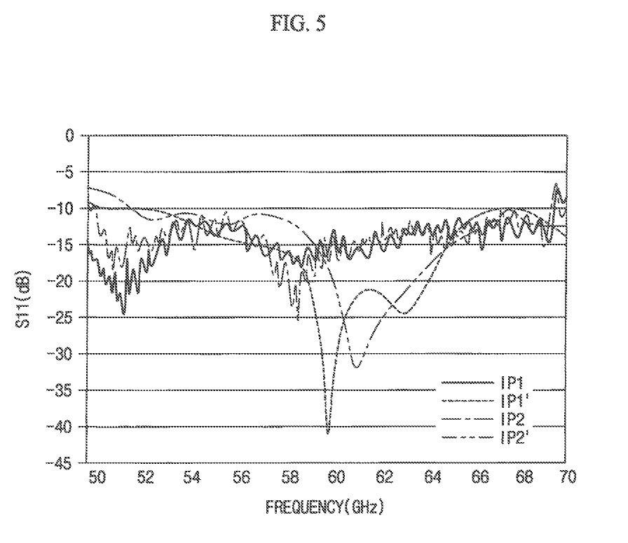

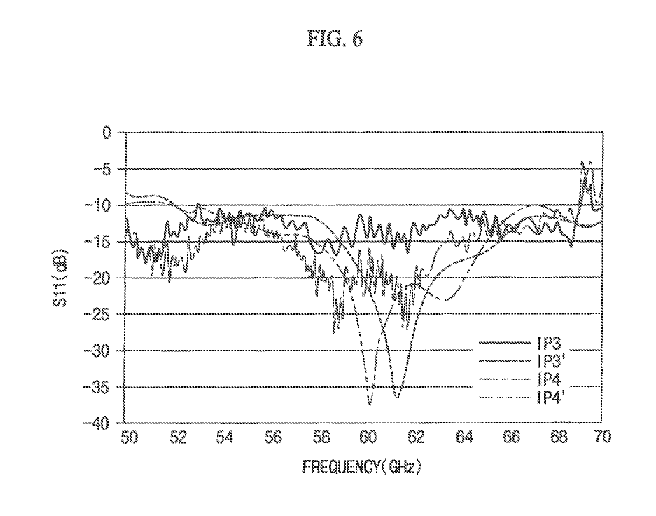

FIGS. 5 and 6 are diagrams for describing an input reflection coefficient of the antenna device of FIG. 1 according to input port signals.

Referring to FIGS. 5 and 6, simulations IP1′ through IP4′ and actual experiments IP1 through 1P4 were performed to measure the input reflection coefficient according to the first through fourth input port signals. In the result of the simulations and experiments, the input reflection characteristic (i.e., S11) was changed as the signal is selectively applied to the first through fourth input ports. Also, it was shown that the radiation efficiency of the antenna was high at the desired frequency, and the frequency bandwidth was broad.

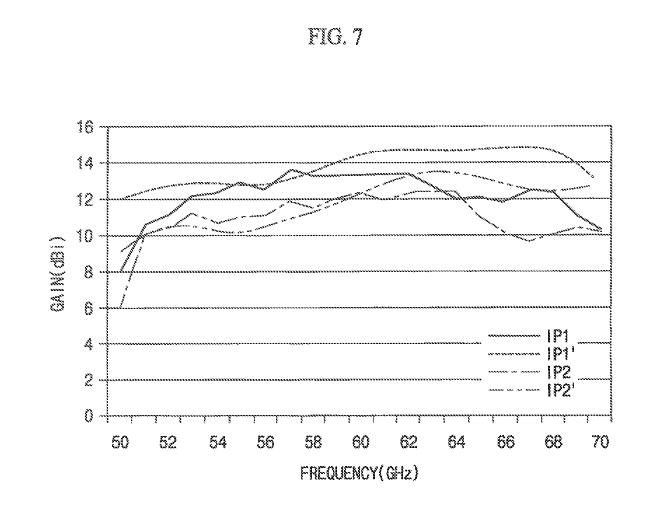

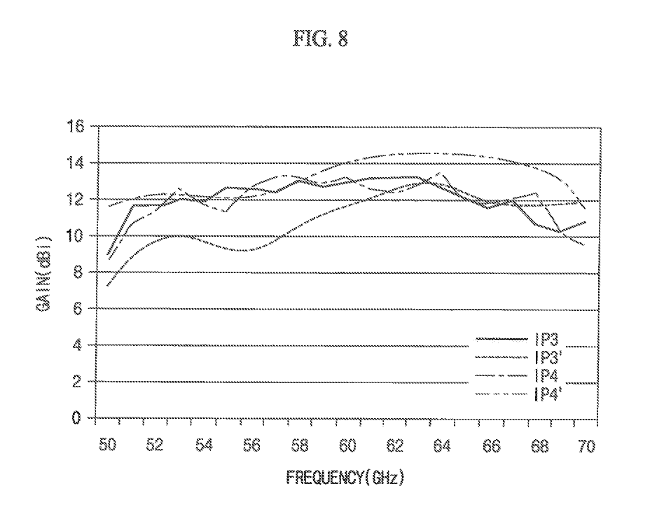

FIGS. 7 and 8 are diagrams for describing an antenna gain of the antenna device of FIG. 1 according to input port signals.

Referring to FIGS. 7 and 8, simulations IP1′ through IP4′ and actual experiments IP1 through IP4 were performed to measure a gain of the antenna according to the first through fourth input port signals. In the result of the simulations and experiments, the antenna device had the antenna gain of 10 dBi or more in most frequency bands as the signal is selectively applied to the first through fourth input ports. Thus, the antenna device according to the present example embodiment had a relatively large antenna gain in comparison with the conventional antenna devices such as Yagi-Uda antenna device, etc.

Therefore, the antenna device AD according to the present invention may incorporate Yagi-Uda antenna capable of performing the beam switching operation into the horn antenna structure, thereby having both advantages of the horn antenna and advantages of the Yagi-Uda antenna.

Specifically, the first comparative antenna device CMP1 including Yagi-Uda antenna may have an advantage of the beam switching operation, however the first comparative antenna device CMP1 may not have a self-shielding effect. In addition, the second comparative antenna device CMP2 including the horn antenna may have advantages of a self-shielding effect, a large antenna gain, and a wide bandwidth, however the second comparative antenna device CMP2 may not perform the beam switching operation. On the other hand, the antenna device AD according to the present invention may include the horn antenna in which the beam switching antenna capable of the beam switching operation is embedded. The antenna device AD may have both advantages of the horn antenna device CMP2 such as self-shielding effect, high antenna gain, and wide bandwidth and advantages of Yagi-Uda antenna device CMP1 such as beam switching.

The below [TABLE 1] summarizes characteristics of the antenna device AD according to the present invention in comparison with characteristics of the first comparative antenna device CMP1 including Yagi-Uda antenna and the second example antenna device CMP2 including the horn antenna.

TABLE 1

| | Yagi-Uda | Horn | Antenna |
|---|---|---|---|
| | Antenna Device | Antenna Device | Device |
| | (CMP1) | (CMP2) | (AD) |
| SIZE | SMALL | BIG | BIG |
| SELF-SHIELDING | IMPOSSIBLE | POSSIBLE | POSSIBLE |
| EFFECT | | | |
| BEAM | POSSIBLE | IMPOSSIBLE | POSSIBLE |
| SWITCHING | | | |
| BANDWIDTH | WIDE | WIDE | WIDE |
| ANTENNA GAIN | SMALL | LARGE | LARGE |

Although the antenna device according to example embodiments have been described with reference to figures, those skilled in the art will readily appreciate that many modifications are possible in the example embodiments without materially departing from the novel teachings and advantages of the present inventive concept. For example, although the example embodiments describe that the antenna device is a horizontal radiation antenna radiating radio waves in a horizontal direction, the antenna device may be a vertical radiation antenna radiating radio waves in a vertical direction.

The present inventive concept may be applied to a wireless communication system including the antenna device. For example, the present inventive concept may be applied to the wireless communication system performing low-power broadband communication.

The foregoing is illustrative of example embodiments and is not to be construed as limiting thereof. Although a few example embodiments have been described, those skilled in the art will readily appreciate that many modifications are possible in the example embodiments without materially departing from the novel teachings and advantages of the present inventive concept. Accordingly, all such modifications are intended to be included within the scope of the present inventive concept as defined in the claims. Therefore, it is to be understood that the foregoing is illustrative of various example embodiments and is not to be construed as limited to the specific example embodiments disclosed, and that modifications to the disclosed example embodiments, as well as other example embodiments, are intended to be included within the scope of the appended claims.

What is claimed is:

1. An antenna device comprising:
a horn antenna including a waveguide and a horn connected to the waveguide, the horn having a shape widening toward an opening direction;
a beamforming network including a plurality of input ports and a plurality of output ports and configured to change a phase of output port signals output from the output ports based on input port signals applied to the input ports; and
an antenna array disposed in the horn antenna and connected to the output ports of the beamforming network.

2. The antenna device of claim 1, wherein the beamforming network includes a butler matrix.

3. The antenna device of claim 2, wherein the butler matrix includes a first stage, a second stage, and a third stage,
wherein each of the first stage and the third stage includes a 3 dB coupler, and
wherein the second stage between the first stage and the third stage includes a 0 dB coupler and a delay line.

4. The antenna device of claim 1, wherein the antenna array includes a Yagi-Uda antenna.

5. The antenna device of claim 1, wherein the antenna array extends from the output ports of the beamforming network in the opening direction at a center line of a cross-section of the horn antenna and is located in the horn.

6. The antenna device of claim 1, further comprising:
a beam switch configured to provide an input signal to one of the input ports of the beamforming network.

7. An antenna device comprising:
a horn antenna having a shape widening toward an opening direction; and
a beam switching antenna extending in the opening direction at a center line of a cross-section of the horn antenna and configured to perform a beam switching operation, the beam switching operation changing a phase of output port signals output from output ports based on input port signals applied to input ports.
